(19) United States
(12) Patent Application Publication
(10) Pub. No.: US 2012/0152095 A1
(43) Pub. Date: Jun. 21, 2012

(54) CAMOUFLAGE APPARATUS AND METHOD

(76) Inventor: Bruce A. Youngman, Plainfield Township, MI (US)

(21) Appl. No.: 13/049,137

(22) Filed: Mar. 16, 2011

Related U.S. Application Data
(60) Provisional application No. 61/316,163, filed on Mar. 22, 2010.

(51) Int. Cl. F41H 3/02; B32B 1/08; B32B 3/24; F41H 3/00; D03D 9/00; F41C 23/00; F41G 1/38; B32B 7/04; B23P 11/00

(52) U.S. Cl. 89/36.01; 29/428; 156/63

(57) ABSTRACT

A camouflage apparatus includes a mesh adapted to receive twigs, leaves, or the like from a given locale, thus allowing an individual to better blend into local scenery. A first panel-type version includes an adhesive with panel of 2D mesh. A second ring-type version includes a ring of 3D mesh material, including a draw string band for securement, or a resilient band forming a brow for engaging a forehead when looking through the scope. These allow the individual to attach natural materials from an existing area, which greatly improves the individual's ability to camouflage his equipment and hide. The illustrated apparatus can be used to cover shiny clothing such as a belt buckle, or can be used to cover equipment, such as a gun scope, a gun barrel or stock, and the like.

### CROSS REFERENCE TO RELATED APPLICATION

This application claims benefit under 35 U.S.C. Section 119(e) of provisional application Ser. No. 61/316,163, filed Mar. 22, 2010, entitled CAMOUFLAGE APPARATUS AND METHOD, the entire content of which is incorporated herein in its entirety.

### BACKGROUND

The present invention relates to camouflaging of sporting equipment such as firearms, hunting bows, cross bows, spotting and hunting optics, hunting gear, paintball, airsoft, camera and related equipment.

There are a plethora of camouflage products. A problem is that the products may work well for a particular outdoor environment but stand out in a different outdoor environment. This is because vegetation and surrounding earth structures differ in a variety of ways, such as in color, shape, density, etc. Also, their appearance changes from season to season (i.e., summer to fall to winter) as well as based on locale (i.e., mountainous versus plains versus meadow, etc). This presents huge challenges for individuals, since a variety of different camouflage must be purchased. Further, often the individual does not know exactly what camouflage will best match the location ahead of time.

### SUMMARY OF THE PRESENT INVENTION

In one aspect of the present invention, a self-adhering camouflage apparatus is provided for disguising equipment. The apparatus includes a carrier sheet including an open mesh material of sufficient grid size to receive at least one of leaves, twigs, grass, and natural debris material extended into the open mesh material and projecting therefrom to create a camouflage using natural materials from a particular locale. The apparatus further includes releasable adhesive on the carrier sheet adapted for releasable adhering attachment to the equipment.

In another aspect of the present invention, a camouflage apparatus for disguising hunting or outdoor equipment includes a carrier including an open mesh material forming a cylindrical ring shaped to be telescopingly placed on an elongated optical component of the equipment, the open mesh material having a grid size sufficient to receive at least one of leaves, twigs, grass, and natural debris material extended into the open mesh material and projecting therefrom to create a camouflage using natural materials from a particular locale.

In narrower a form, a combination is formed with the outdoor equipment and the carrier.

In another narrower form, the carrier includes one of a draw string retainer and a resilient brow for disguising or breaking up an otherwise well defined outline.

In another aspect of the present invention, a method includes releasably attaching a camouflage material to hunting, sporting, photographic or outdoor equipment, the material including a mesh material with an open mesh, and inserting at least one of twigs, leaves, grass, and natural debris material into the mesh in order to provide a camouflage using natural materials from a particular locale.

These and other aspects, objects, and features of the present invention will be understood and appreciated by those skilled in the art upon studying the following specification, claims, and appended drawings.

### BRIEF DESCRIPTION OF DRAWINGS

FIG. 1 is a perspective view of a hunter with a gun and scope, and the present camouflage apparatus on his person, including an adhesive-attaching panel version of the camouflage on his side pocket, his belt buckle, and his hat, parts of his gun and having a cylindrical ring version of the camouflage on front of his scope.

FIG. 2 is a perspective view of the adhesive-attaching panel version in FIG. 2, and FIG. 3 is an exploded cross sectional view of FIG. 2.

FIGS. 4-5 are front and rear end perspective views of a first cylindrical ring version of the camouflage.

FIG. 6 is an end perspective view of a second cylindrical ring version of the camouflage.

FIG. 7 is an enlarged perspective view of the gun and scope in FIG. 1, including the ring versions from FIGS. 4 and 6 on the objective end of the scope, and including the adhesive-attaching panel version on a stock of the gun.

FIG. 8 is a further modified version of the ring version of FIG. 4.

### DETAILED DESCRIPTION OF PREFERRED EMBODIMENTS

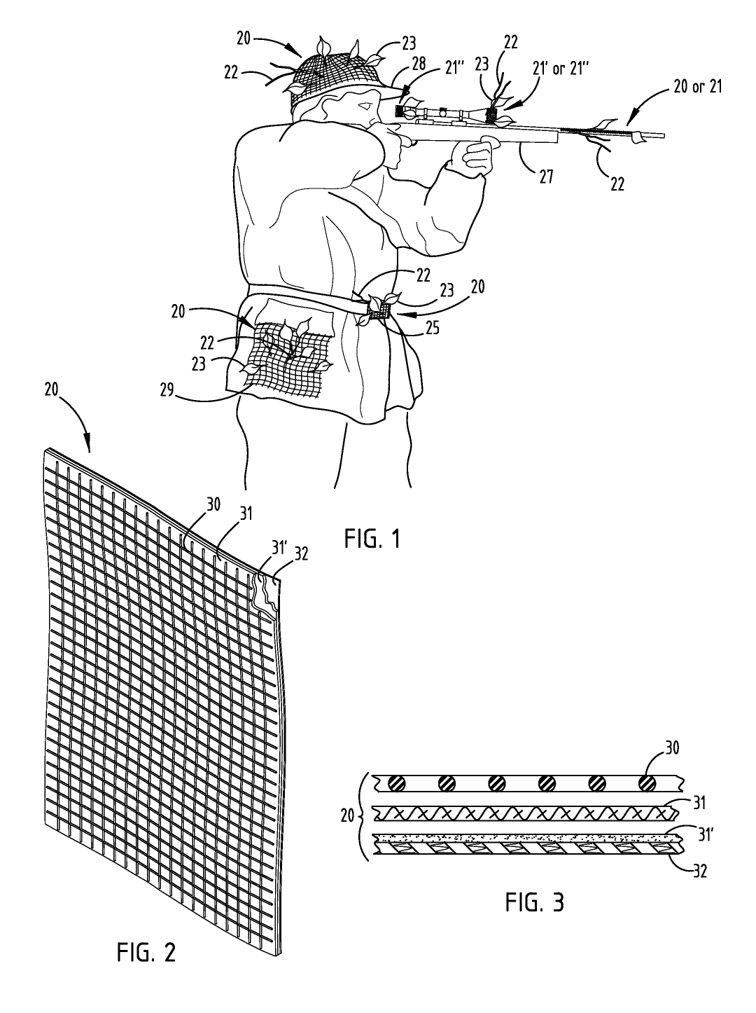

The illustrated camouflage apparatus (FIG. 1) includes two primary types, a first (panel-type) apparatus 20 being an adhesive-attaching panel carrying an open 2D mesh adapted to receive twigs 22, leaves 23, grass, and/or other debris from a particular locale inserted therein, and the second (ring-type version) apparatus 21′ being a cylindrical ring of open 3D mesh adapted to receive twigs 22, leaves 23, grass and/or other debris inserted therein. Each are adapted to allow the hunter to attach twigs, leaves, and debris from an existing area or locale, which greatly improves the hunter's ability to hide in his existing surroundings by using local materials rather than guessing prior to beginning a hunt. The illustrated first adhering panel apparatus 20 can be used, for example, to cover a shiny pocket on the hunter's jacket, or the hunter's belt buckle 25, or the hunter's hat, or hide another shiny or flat area with “visible giveaway lines” on the hunter forming an item that can be seen by prey in a given surrounding. The illustrated second ring apparatus 21″ is used to cover shiny front end of the gun scope 26 and/or the gun's barrel 21 or stock, as discussed below. Notably, material 20 may also be used on a barrel.

FIGS. 2-3 illustrate details of the panel-type apparatus 20. The panel apparatus 20 (also called “Gillie Tape”) has adhesive-carrying panel of 2D mesh, having an open mesh size of about ⅛″ to ¼″ size, or more preferably about ⅛″ size. The open mesh is sufficient in size to allow sticks, twigs, grass, leaves and/or other “debris” picked from a particular hunting site, the mesh being of sufficient size to receive and hold them as they are poked into the mesh.

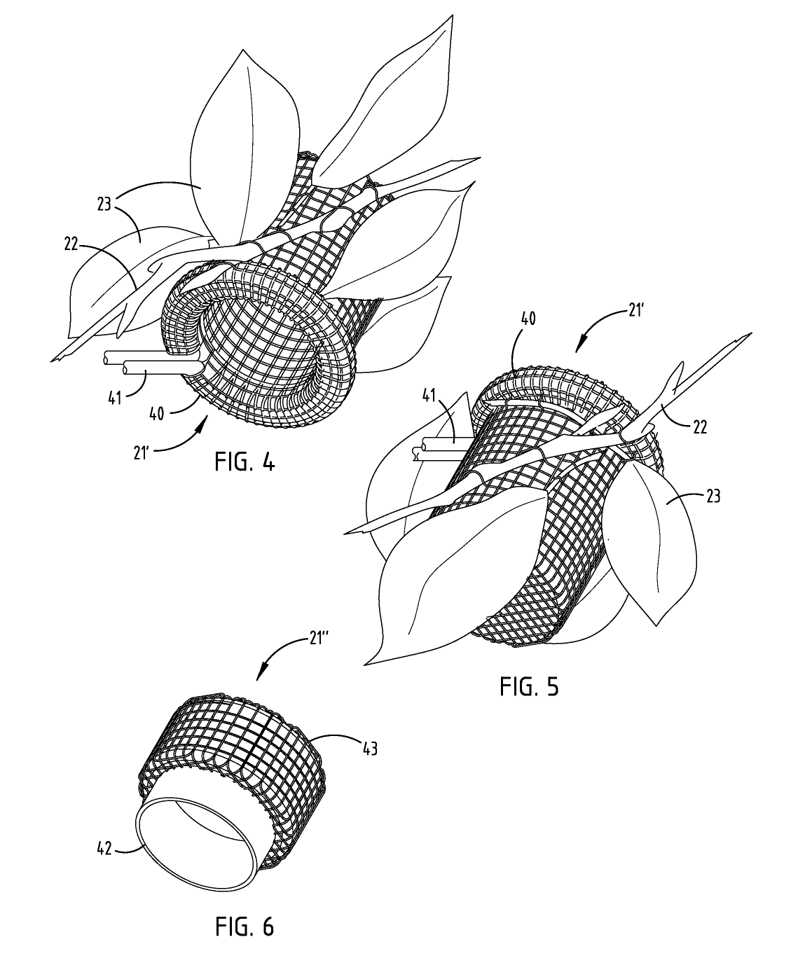

Specifically, the panel apparatus 20 (FIG. 4) includes a 2D open mesh 30 (such as ⅛ inch mesh size) loosely attached to the front surface of a base carrier panel 31, with tacky releasable adhesive 31′ on a back side of the panel. The adhesive 31′ is covered with release paper 32 until use, or can be supplied by stacked sheets (similar to the infamous Post-It® note pads produced by 3M Company). The visible front surface of the illustrated panel 31 includes a realistic photograph of tree limbs or of blotchy patches for a first level of camouflage. However, it is contemplated that a photorealistic base need not be present, since the apparatus will be substantially covered with twigs and the like. In FIGS. 2-3, a bottom end of the twig 22 is inserted through or into the 2D mesh 30 to secure the twig 22 to the apparatus 20 or apparatus 21′. The base adhesive material 31′ is preferably a high tack “removable” releasable material which leaves no residue when removed. For example, 3M materials 24S56W, 44S56W and 64S58W will work. The 2D mesh is attached to the carrier material panel 31 along edges, or attached directly, or can envelop the carrier panel and be held in place by the adhesive. The base carrier panel material and the mesh material are chosen for compatibility in case of edge bonding. The “wrap around” method of product fabrication is not sensitive to material type. The base carrier panel is a material selected to protect the underlying equipment from mars and scratches. Notably, the panel apparatus 20 can be wrapped around an object, such as a rifle scope, and adhered to itself as well as to the rifle, in order to provide a more secure attachment.

The ring apparatus 21′ (FIGS. 4-5) is large enough to basically form a cylindrical sock or ring around the object it protects. For example, the illustrate ring apparatus 21′ forms a ring of sufficient diameter to fit nicely around a front end of a rifle scope, where it reduces glare and reflection from the front glass of the scope. The ring is made of a batting or mesh material (or wool) which allows insertion and removal of materials to “break up” the physical appearance of the scope. Notably, some of the inserted materials may cross in front of the lens or front glass of the scope, since the inserted materials tend to have minimal effect on optical performance since they are positioned away from the focal or image planes of the scope. The material is an open mesh material, having a mesh size similar to that described above for the apparatus 20.

The apparatus 21′ (FIGS. 4-5) includes an elongated ring mesh material 40 with a tunnel sewn in one end, with a draw string 41 of friction-generating material extended through the draw string 41. Once positioned on a scope, the draw string 41 can be pulled to draw tight the ring on the scope. The draw string 41 can be any material. However, rubber coated material works well since it provides sufficient friction to retain the draw string in its tightened position. Alternatively, a friction slide retainer can be used. The illustrated apparatus 21′ can be made large enough for use on the butt end of a gun, or for covering a tip portion of a bow. Alternatively, the end panel can be removed, and the apparatus 21′ used on the front of a scope. Notably, it is possible to see clearly through the closed end of the mesh material 40 even though one end is partially covered or closed due to the openness of the mesh and the optics of the scope, which focuses on far away distances such that it minimizes any visual distortion due to close objects.

FIG. 6 is a perspective view of a modified apparatus 21″, where an annular ring of resilient material, such as rubber, is attached to an end of the ring. The annular ring extends from an end of the apparatus 21″, thus forming a brow that engages a person's forehead when looking through the scope. The resilient ring can also form a retainer for resiliently securing the apparatus 21″ to the scope.

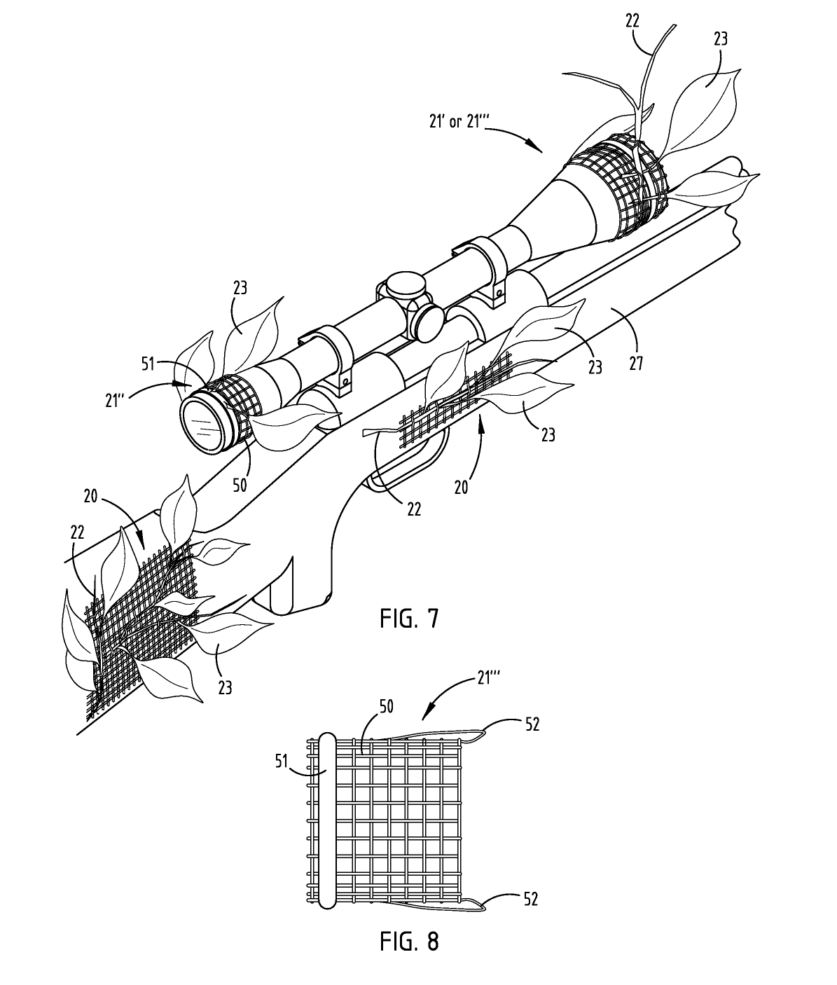

FIG. 7 illustrates a gun with scope, where the apparatus 20, 21′ and 21″ (or 20, 21′, and 21′″) are attached to the gun's stock and scope for camouflage purposes. Specifically, the apparatus 20 is attached to the gun stock to break up lines visible from a side of the gun, and the apparatus 20, 21′ and 21″ (or 20, 21′, and 21′″) are attached to the end of the scope to reduce glare and also cover lines of the scope. Additional camouflage apparatus can be placed on the gun, such as along a side of the gun or its barrel.

FIG. 8 shows a modified apparatus 21′″ that is similar to apparatus 21′, but that includes a mesh 50 with resilient/extensible rubber band retainer 51 for attachment and a band of mesh material 52 forming a brow that overhangs a front end of the scope. This makes it easier to attach and position leaves, twigs, and debris in a position in front of the front glass of the scope where they will prevent “flashing” and unwanted reflection by the glass.

It is to be understood that variations and modifications can be made on the aforementioned structure without departing from the concepts of the present invention, and further it is to be understood that such concepts are intended to be covered by the following claims unless these claims by their language expressly state otherwise.

The embodiments of the invention in which an exclusive property or privilege is claimed are defined as follows:

1. A self-adhering camouflage apparatus for disguising equipment such as outdoor equipment, comprising:
a carrier sheet including an open mesh material of sufficient grid size to receive at least one of leaves, twigs, grass, and natural debris material extended into the open mesh material and projecting therefrom to create a camouflage using natural materials from a particular locale; and
releasable adhesive on the carrier sheet adapted for releasable adhering attachment to the equipment.

2. The apparatus defined in claim 1, wherein the mesh material includes an open mesh size of at least about ⅛ inch.

3. The apparatus defined in claim 2, wherein the open mesh size is less than about ½ inch.

4. The apparatus defined in claim 2, wherein the mesh material includes an open mesh size of about ¼ inch.

5. A combination including sporting equipment and including the apparatus defined in claim 1 releasably adhered to a portion of the equipment.

6. The combination defined in claim 5, wherein the equipment includes a gun stock, and wherein the carrier sheet is attached to the gun stock.

7. A camouflage apparatus for disguising hunting or outdoor equipment, comprising:
a carrier including an open mesh material forming a cylindrical ring shaped to be telescopingly placed on an elongated optical component of the equipment, the open mesh material having a grid size sufficient to receive at least one of leaves, twigs, grass, and natural debris material extended into the open mesh material and projecting therefrom to create a camouflage using natural materials from a particular locale.

8. A combination including a gun with a scope, and including the apparatus defined in claim 7, with the carrier telescoped onto an end of the scope.

9. The apparatus defined in claim 7, including a retainer attached to the carrier for securing the carrier on the optical component.

10. The apparatus defined in claim 9, wherein the retainer includes a draw string.

11. The apparatus defined in claim 7, including an annular rubber brow attached to an open end of the carrier for positioning against hunter's forehead when the hunter is looking through the scope.

12. The apparatus defined in claim 7, wherein the mesh material includes an open mesh size of greater than about ⅛ inch.

13. The apparatus defined in claim 12, wherein the mesh material includes an open mesh size of at least about ¼ inch.

14. A method comprising steps of:
releasably attaching a camouflage material to equipment, the material including a mesh material with an open mesh; and
inserting at least one of twigs, leaves, grass, and natural debris material into the mesh in order to provide a camouflage using natural materials from a particular locale.

15. The method defined in claim 14, including a step of providing adhesive on the camouflage material, and wherein the step of releasably attaching includes adhering the camouflage material to the equipment.

16. The method defined in claim 14, wherein the camouflage material forms a cylindrical ring, and the step of releasably attaching includes positioning the ring on an end of the equipment in a secured position.

17. The method defined in claim 16, wherein the mesh material includes an open mesh size of about ⅛″ to ½ inch, and the step of inserting includes inserting the one material into the mesh.

18. The method defined in claim 17, wherein the mesh material includes an open mesh size of about ¼ inch.

19. The method defined in claim 14, wherein the equipment includes a visible surface, and including releasably adhering the apparatus to the visible surface of the hunting equipment.

20. The method defined in claim 19, wherein the equipment includes a scope, and including attaching the apparatus to the scope.
